(19) United States
(12) Patent Application Publication
(10) Pub. No.: US 2019/0312435 A1
(43) Pub. Date: Oct. 10, 2019

(54) Regenerative and Sustainable Energy Structures

(71) Applicant: INFINITE KINGDOMS LLC, Wakefield, RI (US)

(72) Inventor: Denise Chapman WESTON, Wakefiled, RI (US)

(73) Assignee: INFINITE KINGDOMS LLC, Wakefield, RI (US)

(21) Appl. No.: 16/375,306

(22) Filed: Apr. 4, 2019

Related U.S. Application Data
(60) Provisional application No. 62/652,868, filed on Apr. 4, 2018.

(51) Int. Cl. H02J 3/38; H02J 7/34; H02J 3/32; H02K 7/18; H02J 7/35; A63G 31/00

(52) U.S. Cl. CPC H02J 3/382; H02J 3/383; H02J 3/386; H02J 7/34; A63G 31/007; H02K 7/1823; H02J 7/35; A63G 31/00; H02J 3/32

(57) ABSTRACT

Regenerative and Sustainable Energy Structures are integrated systems that harness the energy in the surrounding environment and the energy created by the structure itself to offset the energy required to operate the system. The systems can combine various sources of energy, such as solar, wind, hydroelectric, and physical power, and direct or store that energy to be used to power the system. For example, a water play attraction can utilize a solar panel shade structure, a hydroelectric generator under a fountain, wind turbines, and generators that can be cranked by participants. The energy generated by each of these components may be returned to the system to operate the water pump that fuels the fountain, for example. The aggregated energy is sufficient to offset the energy consumption of the system in whole or in part, and may even generate a surplus of energy that can be returned to the electrical grid.

### TECHNICAL FIELD

This disclosure generally relates to regenerative and sustainable energy structures to be used in interactive environments and displays (including play attractions, amusement rides, sculptures, pods, and other environments), whereby the interaction with the environment or display, in combination with other renewable energy sources, provide some or all of the energy necessary to operate the environment or display, or it may provide energy to contribute to the energy grid or it may be used to operate other nearby environments or displays or it may be used for any combination of those uses.

### BACKGROUND

Amusement parks, water parks, museums, shopping centers, office buildings, residences, city parks, and other attraction, retail, or entertainment-based properties often host interactive attractions and artistic displays, where individuals can interact with the environment or observe an artistic display in motion. For example, a water park attraction might contain water fountains, ground sprayers, spray pools, zero depth play areas, activity pools, soakers, dumping buckets, wave pools, water slides, towers, shade structures, and other single or multi-level play structures made of heavy materials, such as aluminum or steel. As another example, a sculpture or artistic display may contain active features, such as a fountain operated by a pump mechanism or moving features operated by a motor. Such interactive attractions typically require large amounts of energy to drive the pumps, motors, drain systems, filters, computers, etc. that allow the attraction to operate. Such presently-existing structures consume large amounts of energy that is typically drawn from municipal electrical grids.

The present invention relates to regenerative and sustainable energy structures and displays, whereby the energy needed to drive or sustain any motion or activity within the structure or display can be drawn from an integrated combination of the ubiquitous renewable energies derived from the environment, including energy from the sun, wind, gravity, heat, geothermal, and emerging renewable energy. In one embodiment, the system may derive some or all of the energy needed to function from a combination of energy generators, including solar panels, wind turbines, and water wheels. The system may incorporate naturally existing resources such as water, wind, sunlight, gravity, heat, geothermal, and emerging renewable energy sources to drive turbines and generators, thereby supplementing the source of energy within the system. For example, if the structure or display incorporates a water fountain or object that moves in the wind, the structure or display may harness the energy created by such components, and help power the structure or display. Similarly, in a kinetic sculpture, the motion of the sculpture itself may be harnessed and employed to operate the sculpture itself, or may be redirected to help power other structures or environments throughout the environment. In yet another embodiment, the regenerative and sustainable energy structures may be supplemented by deriving energy from participants engaging in activities such as jumping, sliding, pulling, lifting, turning, pumping, or cranking objects within the environment, which may convert the kinetic energy expended into potential energy stored in a battery or other storage device or distributed to operate other components of the structure. While the energy produced by an individual participant turning a crank, for example, may be relatively small compared to the overall needs of the attraction, the overall energy produced by the combination of harnessed forces may be sufficient to offset, adequately supply, or even exceed the total energy demands, and may return energy to the grid.

As the regenerative energy system generates energy, either from interactive action by a participant, or from renewable energy sources, the system may produce an indication that energy is being created to highlight the benefit of regenerative and renewable energy. For example, in a water park, as a participant sprays water on a wheel, and the force of the water turns a wheel, which turns a generator, the system may use some of the generated energy to activate a sound or music or visual display, or emit smoke to demonstrate that the participant has produced energy. Similarly, in the example of a kinetic sculpture, as wind blows through wind turbines placed throughout the sculpture, a lighting display may be activated, reflecting that the sculpture is harnessing and regenerating energy.

This regenerative and sustainable energy structure provides for reduced energy consumption, and therefore a more economical operation of the system and environmental impact. Indeed, certain renewable energies may be used to generate energy at all times of day. For example, wind energy and geothermal energy can be harnessed 24 hours a day, 365 days a year, and may keep the environment or display in operation at all times, and may produce, store, and distribute energy to other systems, attractions, locations, or the energy grid at any time.

In addition to the economic and energy-saving advantages, the regenerative energy structure provides the added benefit of allowing the participants to enjoy contributing to the operation of the system, and permits observers to learn about and appreciate sustained and renewable energy. In addition, in an interactive play environment, the system may track the energy production by participants, and the participants may enjoy competing to see who can produce the most energy.

In a typical attraction or display, the structures are made from relatively heavy materials, such as aluminum, steel, concrete, etc. To aid in the efficiency of the regenerative and sustainable energy environment, the structures may be constructed out of lighter-weight materials, including tension fabrics, which can be flexibly molded or stretched into appropriate shapes, and once formed, offer excellent rigidity and strength. Due to the light weight, and inherent strength of tension fabrics, they can be used to create a wide variety of ornamental designs, that not only are aesthetically pleasing or interesting, but perform useful functions and support. Tension fabrics can be used to channel air, channel water, create handrails, slides, flooring, roofing, soft sculpture, sunlight protection and shade. Tension fabrics can be printed, welded, sewn and wired into place.

### BRIEF DESCRIPTION OF THE DRAWINGS

FIG. 1 illustrates an example pulley device for generating energy by a participant in accordance with a non-limiting embodiment of the present disclosure.

FIG. 2 illustrates an example energy production, conversion, and storage system in accordance with a non-limiting embodiment of the present disclosure.

FIG. 3 illustrates an example photovoltaic cell arrangement on a molded tension fabric structure with a non-limiting embodiment of the present disclosure.

FIG. 4A illustrates an example large windmill/turbine structure in accordance with a non-limiting embodiment of the present disclosure.

FIG. 4B illustrates an example collection of small-scale windmill/turbine structures in accordance with a non-limiting embodiment of the present disclosure.

FIG. 5 illustrates an example of a mechanical energy generation device in accordance with a non-limiting embodiment of the present disclosure.

FIGS. 6A, 6B, 6C, and 6D illustrate example diagrams of structures made of tension fabrics in accordance with a non-limiting embodiment of the present disclosure.

FIG. 7 illustrates an example block diagram of a system for storing and distributing energy to components with an interactive environment in accordance with a non-limiting embodiment of the present disclosure.

### DESCRIPTION OF EXAMPLE EMBODIMENTS

### Regenerative and Sustainable Energy Systems

The teachings of the present disclosure describe regenerative and sustainable energy systems, whereby the system or display utilizes the energy produced by the environment and the system itself (perhaps in combination with participants in the system) to operate or aid in the operation of the components of the system. The present disclosure also describes the use of renewable energy, such as light, water, gravity, heat, wind, geothermal, and emerging renewable energy sources to supplement the energy produced by the participants. Ultimately, the regenerative and sustainable energy systems may reduce the amount of energy from the electrical grid required for operations, may produce enough energy to run the entire system, and may even produce enough energy to contribute to the surrounding attractions or environments. Accordingly, a regenerative and sustainable energy system or display may be connected to an electrical grid, completely self-sustaining and removed from an electrical grid, or the system may actually contribute electrical energy to other connected environments or systems.

In certain embodiments, the system may harness kinetic energy produced by the system itself and the environment around it to operate or contribute to the operation of the system. For example, the structure may contain solar panels that harvest energy from the sunlight, water wheels that harvest hydroelectric power from water run out from water fountains or water slides, and wind turbines that harvest wind energy from the surrounding wind. While one of the electrical generators alone may be insufficient, the system aggregates the energy from each of these components to derive sufficient energy to operate the system in whole or in part, and may even generate energy that may be returned to the electrical grid and may be used to operate or help operate surrounding structures.

In certain embodiments, the system converts the kinetic energy expended or created by participants in the environment into potential energy that can be utilized and/or stored to operate various components of the system, including water pumps, wave pools, and electronic devices.

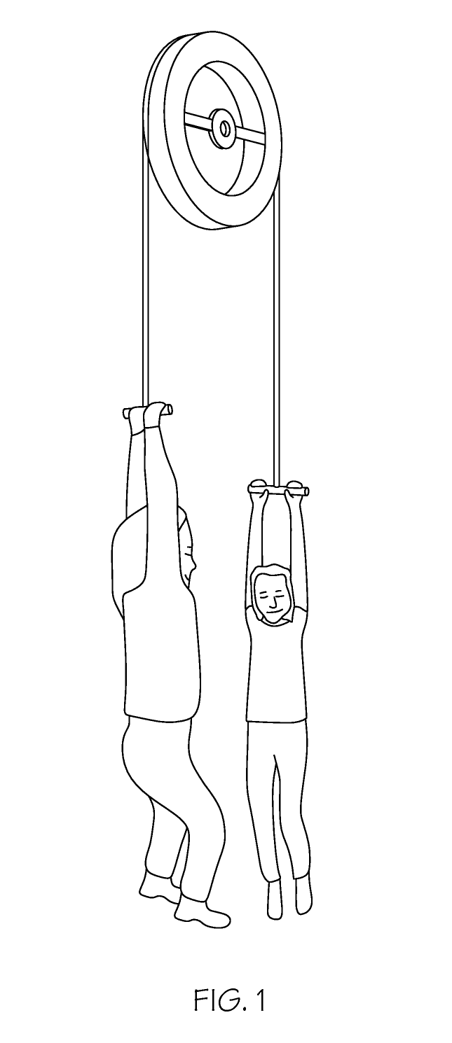

In certain embodiments, the participant may produce energy by stepping or jumping on floor tiles, turning a crank, pulling on a rope, or sliding through a tube. For example, with reference to FIG. 1, the participants may pull on a rope that is attached to a generator, that may convert the kinetic energy of the participant into stored energy to be used to operate the system.

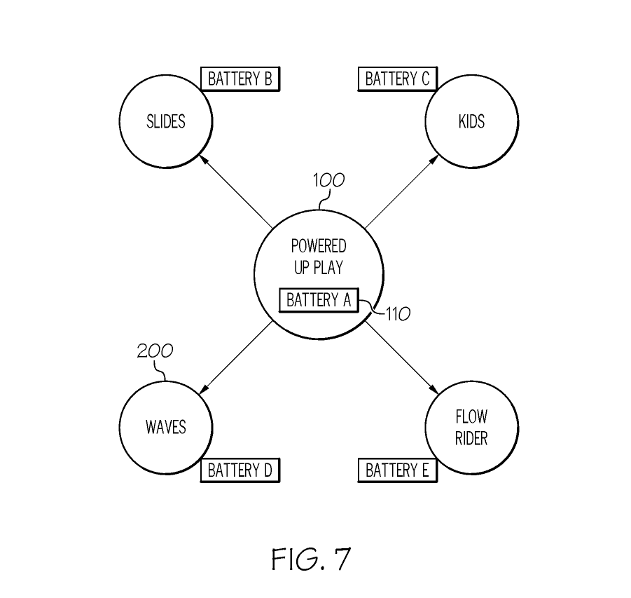

With reference to FIG. 7, different components of a regenerative structure or environment can independently create and store its own energy, and this energy can be transferred to other components or environments to aid their operation. For example, the kinetic energy produced by the powered up play structure (100) can be stored in battery (110), and transferred to other components, such as the wave machine (200).

In certain embodiments, the observer or participant may download an application, which can be used to interact with the environment or display. For example, a participant may download an app on their smart phone that includes augmented reality. When the smart phone is help up to the attraction or display, the augmented reality app may show the inner workings of the attraction or display, and demonstrate how the energy is being generated, stored, distributed, and used. In another embodiment, augmented reality may be used to demonstrate additional effects or games based on the regeneration of energy.

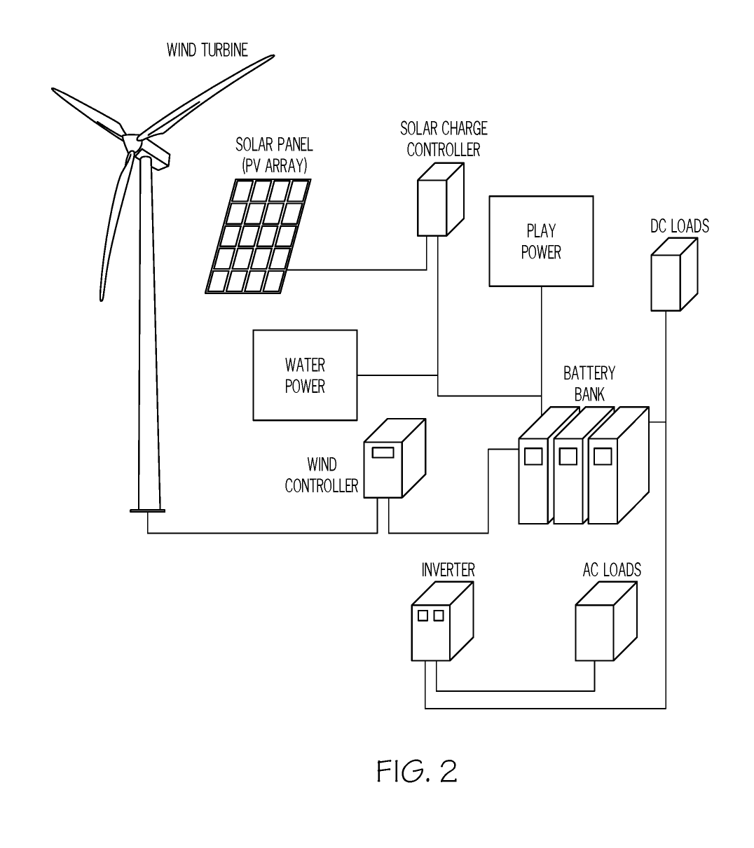

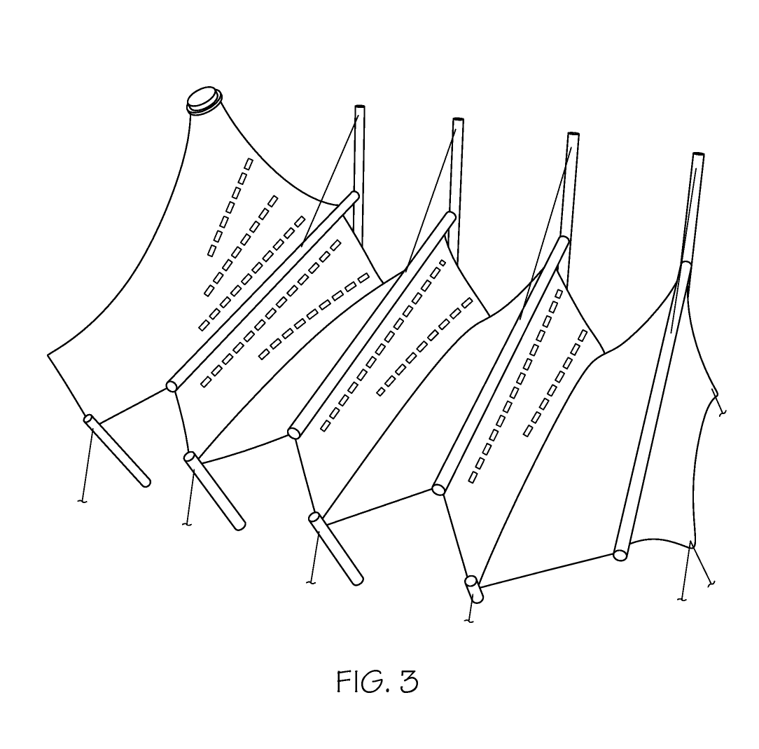

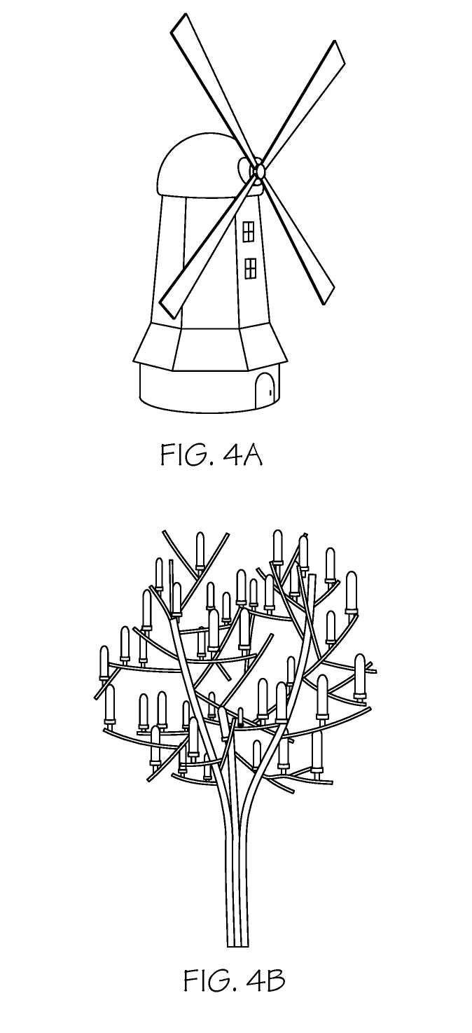

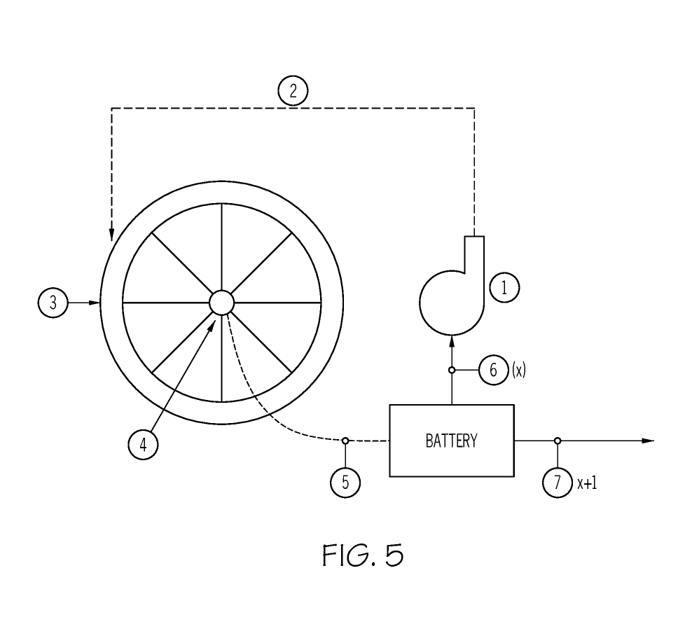

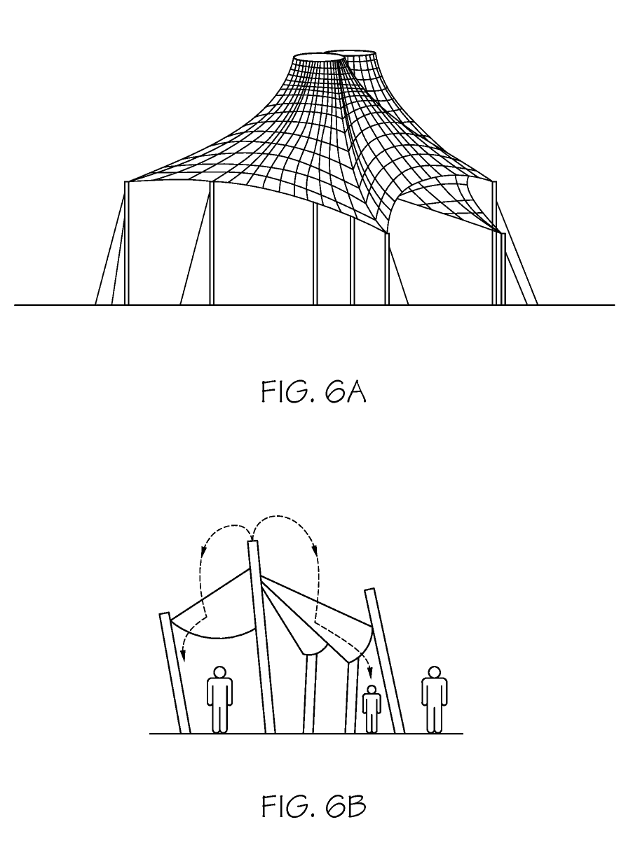

In an additional embodiment, the regenerative energy environment or display may harness naturally existing energy sources to generate stored energy. For example, with reference to FIG. 2, the system may include a wind turbine (100) and a solar panel (200). Each respective component is associated with a controller (300 and 400) that converts kinetic energy into energy to be stored in a battery bank (400). This stored energy may be distributed and used to operate other features of the environment or display. In another embodiment, with reference to FIG. 3, photovoltaic cells may be used to harvest energy from sunlight. This energy may also be stored and used to operate other features of the environment or display. In yet another embodiment, with reference to FIG. 4A, wind turbines may be utilized to harvest wind energy, which may be stored and used to operate other features of the environment. Similarly, with reference to FIG. 4B, smaller wind turbines can be used to vary the visual and thematic presentation, while still generating energy that can be store and used. In yet another embodiment, the regenerative and sustainable energy play system may rely on the force of gravity to generate energy. For example, with reference to FIG. 5, stored energy from the battery (100) may be used to operate a pump (200), which propels water into the air, which then pours over top of a generator (300). As the water pours over a generator (300) due to the force of gravity, the generator may convert the energy produced by the falling water to energy to be stored battery (100). The energy stored in battery (100) may also be used to power other components within the system, or to power components of other systems within the same or nearby attractions.

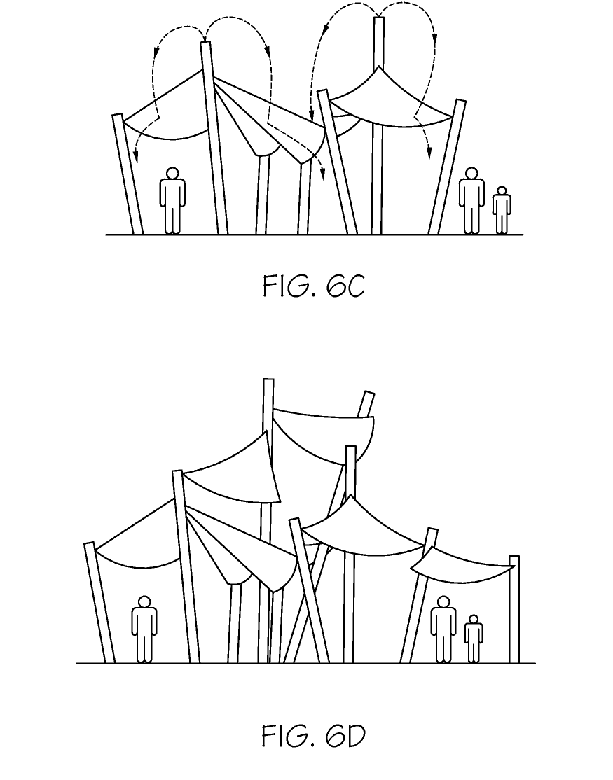

In each of the aforementioned embodiments, with reference to FIGS. 6A-6D, the features may be constructed out of tension fabrics, which are lighter-weight, and may be shaped into efficient designs that may maximize the production of energy. As depicted in FIGS. 6A-6D, tension fabrics are flexible and can be molded into various shapes and designs. These molded and shaped structures can serve functions, including channeling air, channeling water, creating handrails, slides, flooring, roofing, soft sculpture, sunlight protection and shade. Tension fabrics can be printed, welded, sewn and wired into place.

In yet another embodiment, the regenerative and sustainable energy structures may be modular in design. For example, the regenerative and sustainable energy system may include a simple tube or pipe with a water fountain and a hydroelectric generator that harnesses energy created by the flowing water and returns the energy to the system. An additional module including a shade structure featuring solar panels may be combined with the water tube module, and the solar power and hydroelectric power generated by respective generators may be aggregated and returned to the system. In addition, a third module comprising a wind turbine may be added to the system, and the energy generated therein may be combined with the energy generated by the water module and the solar module to contribute to the operation of the system. In addition, a play module may be added wherein energy created by participants, such as by cranking a wheel, may be aggregated with the energy created by the other modules to operate or aid in the operation of the system. Any number and variety of modules may be combined to create an integrated regenerative and sustainable energy system. The combination of modules may take the form of a multi-level structure and/or play structure.

In each of the aforementioned embodiments, existing structures, such as water slides, may be retrofitted to incorporate regenerative energy systems and generators (such as solar panels, wind turbines, hydroelectric generators, and piezoelectric tiles, for example), such that the existing structures can be transformed into integrated regenerative and sustainable energy structures that harness the energy around them and created by them, and help create an environmental impact by offsetting the energy necessary to operate them.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of the advantages.

What is claimed is:

1. A system comprising:
A physical structure;
One or more motors or pumps for operating one or more components associated with said physical structure;
One or more renewable energy generators associated with said physical structure;
Wherein the energy generated by the one or more renewable energy generators may be used to provide power for the one or more components of the system.

2. The system of claim 1 wherein the physical structure is a play structure.

3. The system of claim 2 wherein the play structure is a water play area, water slide, water ride, wave pool, or fountain.

4. The system of claim 1 wherein the physical structure is an artistic structure or sculpture.

5. The system of claim 1 wherein the system utilizes a combination of two or more renewable energy generators to provide power to the one or more components of the system, selected from a hydroelectric generator, a solar power generator, a wind power generator, a human-powered generator, a piezoelectric generators, a geothermal generator, and a wave power generator.

6. The system of claim 1 wherein the renewable energy generators are retrofitted onto an existing physical structure and the energy generated by the renewable energy generators is integrated into the system to offset some of the energy consumed by the system in operation.

7. The system of claim 1 wherein interactive play produces energy that is contributed to the system to provide power for the one or more components of the system.

8. The system of claim 7 wherein the interactive play consists of spinning, turning, cranking, pulling, lifting, kicking, pushing, sliding, or pumping an object, or jumping up and down, which in turn turns a generator which produces energy to be used by the system.

9. The system of claim 1 wherein the energy created by the renewable energy generators is stored in a battery and used to operate the system as needed.

10. The system of claim 1 wherein the energy created by the renewable energy generators exceeds the energy required to operate the components of the structure, and energy is transferred to the electrical grid or stored.

11. The system of claim 1 wherein the energy generated by the renewable energy generators and/or interactive play is reflected on a visual, musical, audio, or physical display.

12. The system of claim 1 wherein all or part of the physical structure is made of tension fabrics.

13. The system of claim 1 wherein the physical structure is modular, and additional physical structures, storage modules, display modules, and renewable energy generator modules can be added on to the physical structure to build a larger system.
